(19) United States
(12) Patent Application Publication
(10) Pub. No.: US 2021/0048612 A1
(43) Pub. Date: Feb. 18, 2021

(54) LENS MODULE

(71) Applicant: AAC Optics Solutions Pte. Ltd., Singapore City (SG)

(72) Inventor: Yuchan Gao, Shenzhen (CN)

(21) Appl. No.: 16/989,908

(22) Filed: Aug. 11, 2020

(30) Foreign Application Priority Data
Aug. 13, 2019 (CN) 201921310011.4

(51) Int. Cl. G02B 13/00; G02B 1/04; H04N 5/225; G02B 3/00

(52) U.S. Cl. CPC G02B 13/003; G02B 1/041; G02B 2003/0093; G02B 3/00; H04N 5/2254

(57) ABSTRACT

A lens module includes a lens barrel including a first barrel wall and a second barrel wall that define a receiving space, and a lens group in the lens barrel and including a first lens that has a first surface, a second surface and a side surface connecting the first surface with the second surface. The side surface includes at least two spaced flat surface sections, and an extending surface sections including a first extending surface section and a second extending surface section. The first extending surface section extends from the second extending surface section in a direction facing away from the optical axis, and the second extending surface section extends from the first extending surface section in the same direction. The first and second extending surface sections cooperate to adjust the incident angle of light and reduce the stray light reflected from the side surface to the imaging surface.

### FIELD

The present invention relates to the field of optical imaging technology, and particularly, to a lens module applied in the field of camera products.

### BACKGROUND

With the advance in science and technology, cameras are widely used. At present, in addition to cameras, mobile phones, computers and other electronic products are all equipped with cameras, with which people can take pictures anytime and anywhere, thereby bringing convenience and entertainment to people's lives.

FIG. 1 is a schematic structural diagram of a lens module known in the prior art. As shown in FIG. 1, the lens module 100′ known in the prior art includes a lens barrel 1′, and a lens group 3′ disposed in the lens barrel 1′ and having an optical axis 30′. The lens barrel 1′ includes a first barrel wall 11′ provided with a light-through hole 10′, and a second barrel wall 12′ extending from the first barrel wall 11′ while being bent. The first barrel wall 11′ and the second barrel wall 12′ together define a receiving space 20′ configured to receive the lens group. The lens group 3′ includes at least a first lens 31′, and the first lens 31′ includes a first surface 311′ close to an object side, a second surface 312′ close to an image side and disposed opposite to the first surface 311′, and a side surface 313′ connecting the first surface 311′ with the second surface 312′. The side surface 313′ is a smooth flat surface. When external light propagates into the first lens 31′, the light is reflected repeatedly by the first lens 31′ and thus propagates within the first lens 31′, forming multiple light paths, as shown by the arrows in FIG. 1, thereby resulting in a lot of stray light in the lens module. Therefore, the imaging quality of the lens module is relatively poor.

In particular, the closer the lens to the object side, the stray light is more serious. In some solutions, a spacing assembly is used to absorb the stray light. Such a method eliminates the stray light reflected onto the imaging surface by a lens closest to the image side to a certain extent. However, the spacing assembly has a high stamping cost and a complex structure.

Therefore, in order to solve the above problems, it is necessary to provide a lens module having a simple structure and a good performance to eliminate the stray light.

### SUMMARY

An object of the present invention is to provide a lens module with a simple structure and a good optical performance.

In order to solve the above technical problems, the present invention provides a lens module. The lens module includes a lens barrel, and a lens group disposed in the lens barrel and having an optical axis. The lens barrel comprises a first barrel wall provided with a light-through hole, and a second barrel wall extending from the first barrel wall while being bent, the first barrel wall and the second barrel wall define a receiving space for receiving the lens group. The lens group comprises at least a first lens, the first lens comprises a first surface close to an object side, a second surface close to an image side and opposite to the first surface, and a side surface connecting the first surface with the second surface The side surface comprises at least two flat surface sections spaced apart from one another in a direction of the optical axis and facing towards the second barrel wall, and an extending surface sections connected between two adjacent flat surface sections of the at least two flat surface sections. The extending surface sections comprise a first extending surface section and a second extending surface section, the first extending surface section is closer to the light-through hole than the second extending surface section, the first extending surface section extends from the second extending surface section in a direction facing away from the optical axis, and the second extending surface section extends from the first extending surface section in the direction facing away from the optical axis.

As an improvement, at least one of the at least two flat surface sections abuts against the second barrel wall.

As an improvement, orthographic projections of the extending surface sections on the second barrel wall are located between orthographic projections of the two adjacent flat surface sections on the second barrel wall.

As an improvement, both the first extending surface section and the second extending surface section are inclined flat surface sections.

As an improvement, each of the at least two flat surface sections has a ring shape.

As an improvement, the at least two flat surface sections are located in a same plane.

As an improvement, an angle included between the first extending surface section and the second extending surface section is an acute angle.

As an improvement, the first lens is a round glass lens or a round plastic lens.

As an improvement, the at least two flat surface sections are evenly spaced apart from one another.

Compared with the prior art, the lens module of the present invention has the following beneficial effects.

1. The first extending surface section cooperates with the second extending surface section in such a manner that the light incident on the side surface from the light-through hole is reflected twice, which significantly increase the light absorption of the side surface, thereby eliminating the stray light reflected from the side surface to the greatest extent.

2. Both the first extending surface section and the second extending surface section are inclined surfaces and cooperate with the flat surface sections, and such a structure is conducive to light extinction treatment and also increases the light absorption of the side surface.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic structural diagram of a lens module known in the prior art;

FIG. 2 is a schematic structural diagram of a lens module provided by present invention;

FIG. 3 is a partially enlarged view of part A shown in FIG. 1;

FIG. 4 is a schematic diagram of the working principle of FIG. 2; and

FIG. 5 is a partially enlarged view of part B shown in FIG. 4.

### DESCRIPTION OF EMBODIMENTS

Hereinafter, the present invention will be described in detail through embodiments in combination with accompanying drawings, for facilitating the understanding of the solutions according to the present invention and its advantages in various aspects. In the following embodiments, a direction from right to left on the paper surface is referred as to a horizontal direction, and a direction perpendicular to the horizontal direction on the paper surface, i.e., from top to bottom of the paper surface, is called a vertical direction. In the present invention, the vertical direction is parallel to a direction of the central axis.

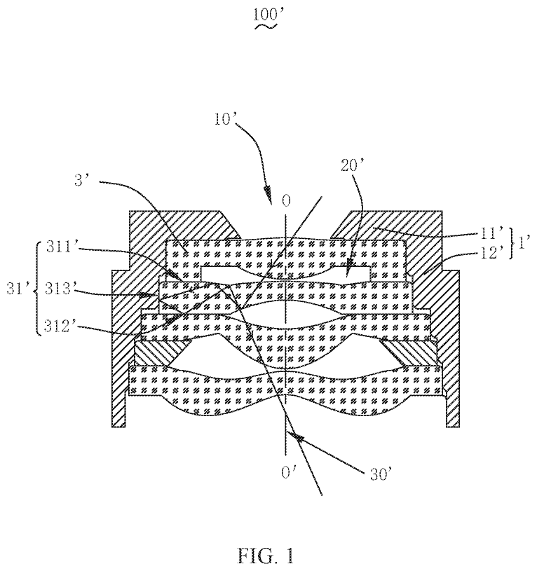

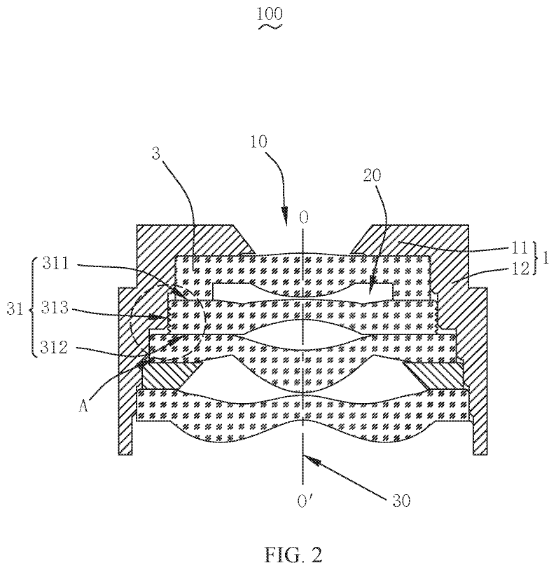

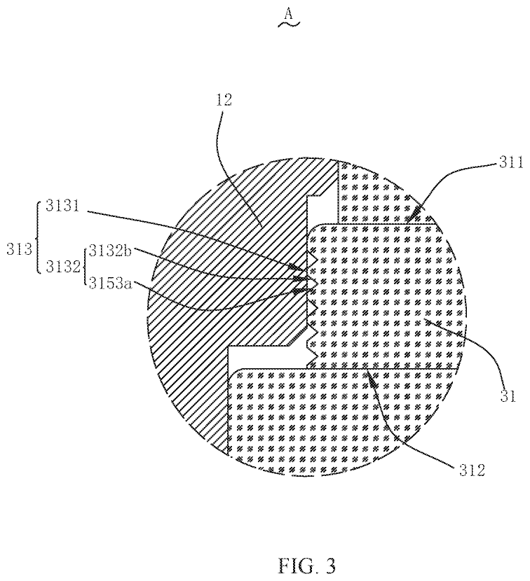

FIG. 2 is a schematic structural diagram of a lens module provided by the present invention, and FIG. 3 is a partially enlarged view of part A shown in FIG. 1. In combination with FIG. 2 and FIG. 3, the lens module 100 includes a lens barrel 1, and a lens group 3 disposed in the lens barrel 1 and having an optical axis 30. The lens barrel 1 includes a first barrel wall 11 provided with a light-through hole 10, and a second barrel wall 12 extending from the first barrel wall 11 while being bent. The first barrel wall 11 and the second barrel wall 12 together define a receiving space 20 configured to receive the lens group 3.

The lens group 3 includes at least a first lens 31. In the present embodiment, the first lens 31 is a round glass lens or a round plastic lens. The first lens 31 includes a first surface 311 close to an object side, a second surface 312 close to an image side and opposite to the first surface 311, and a side surface 313 connecting the first surface 311 with the second surface 312.

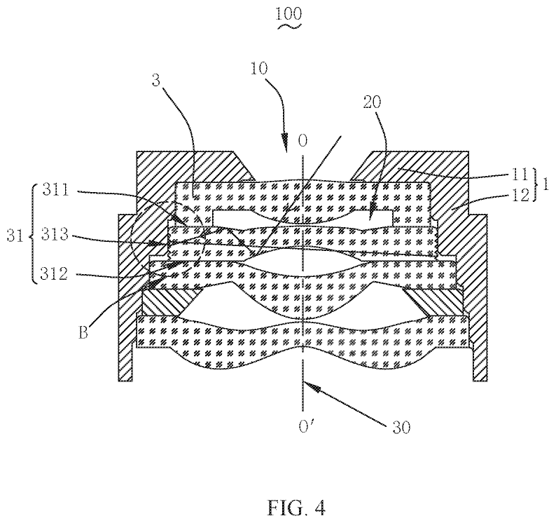

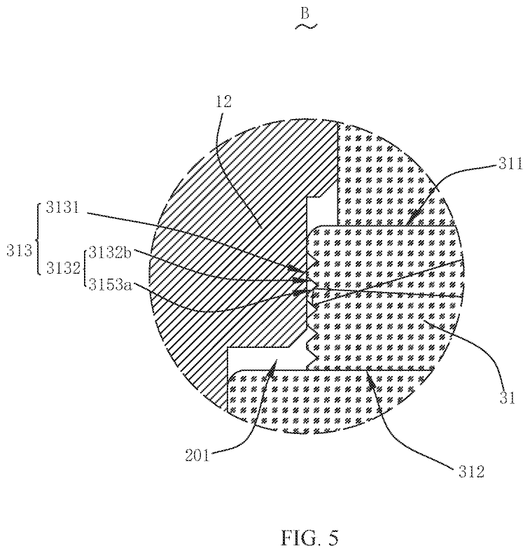

FIG. 4 is a schematic diagram of a working principle of FIG. 2, and FIG. 5 is a partially enlarged view of part B shown in FIG. 4. Referring to FIG. 4 and FIG. 5 together, the side surface 313 includes at least two flat surface sections 3131 spaced apart from each other along a direction of an optical axis 30. The flat surface sections 3131 face towards the second barrel wall 12, at least one of the flat surface sections 3131 abuts against the second barrel wall 12, and the other flat surface sections 3131 are spaced apart from the second barrel wall 12 with a spacing 201. After the light is reflected by the first lens 31, a part of the light entering the spacing 201 is incident on the second barrel wall 12, thereby further eliminating the stray light. For example, the flat surface sections 3131 are equally spaced, and each of the flat surface sections 3131 has a ring shape.

The side surface 313 further includes extending surface sections 3132 each connected between two adjacent ones of the flat surface sections 3131. Specifically, all the flat surface sections 3131 are located on the same plane, and the extending surface section 3132 includes a first extending surface section 3132a and a second extending surface section 3132b. The first extending surface section 3132a is closer to the light-through hole 10 than the second extending surface section 3132b. The first extending surface section 3132a extends from the second extending surface section 3132b in a direction facing away from the optical axis 30, and the second extending surface section 3132b extends from the first extending surface section 3132a in a direction facing away from the optical axis 30.

In the present embodiment, both the first extending surface section 3132a and the second extending surface section 3132b are inclined flat surface sections, and an angle included between the first extending surface section and the second extending surface section is an acute angle. Such a configuration is advantageous for light extinction treatment, which can be realized by increasing the roughness of the flat surface sections 3131, i.e., the first extending surface section 3132a and the second extending surface section 3132b.

The first extending surface section 3132a cooperates with the second extending surface section 3132b. As indicated by the continuous arrows in FIG. 5, the light incident on the side surface 313 from the light-through hole 11 is reflected twice, which greatly increases the light absorption of the side surface 313, thereby eliminating the stray light reflected by the side surface 313 to the greatest extent.

It should be noted that, an orthographic projection of each extending surface section 3132 between two adjacent flat surface sections 3131 on the second barrel wall 12 is located between orthographic projections of the two adjacent flat surface sections 3131 on the second barrel wall 12, so as to ensure that most of the light incident from the light-through hole 10 is incident on the extending surface sections 3132.

Compared with the prior art, the lens module 100 of the present invention has the following beneficial effects:

1. The first extending surface section cooperates with the second extending surface section in such a manner that the light incident on the side surface from the light-through hole is reflected twice, which significantly increase the light absorption of the side surface, thereby eliminating the stray light reflected from the side surface to the greatest extent.

2. Both the first extending surface section and the second extending surface section are inclined surfaces and cooperate with the flat surface sections, and such a structure is conducive to light extinction treatment and also increases the light absorption of the side surface.

The above are merely some embodiments of the present invention, but not intended to limit the scope of the present invention. Any equivalent structures or modifications based on the contents of the description and the drawings of the present invention, or direct or indirect applications in other related technical fields shall be included in the protection scope of the present invention.

What is claimed is:

1. A lens module, comprising:
a lens barrel; and
a lens group disposed in the lens barrel and having an optical axis,
wherein the lens barrel comprises a first barrel wall provided with a light-through hole, and a second barrel wall extending from the first barrel wall while being bent, the first barrel wall and the second barrel wall define a receiving space for receiving the lens group,
wherein the lens group comprises at least a first lens, the first lens comprises a first surface close to an object side, a second surface close to an image side and opposite to the first surface, and a side surface connecting the first surface with the second surface,
wherein the side surface comprises at least two flat surface sections spaced apart from one another in a direction of the optical axis and facing towards the second barrel wall, and an extending surface sections connected between two adjacent flat surface sections of the at least two flat surface sections, and
wherein the extending surface sections comprise a first extending surface section and a second extending surface section, the first extending surface section is closer to the light-through hole than the second extending surface section, the first extending surface section extends from the second extending surface section in a direction facing away from the optical axis, and the second extending surface section extends from the first extending surface section in the direction facing away from the optical axis.

2. The lens module as described in claim 1, wherein at least one of the at least two flat surface sections abuts against the second barrel wall.

3. The lens module as described in claim 2, wherein orthographic projections of the extending surface sections on the second barrel wall are located between orthographic projections of the two adjacent flat surface sections on the second barrel wall.

4. The lens module as described in claim 3, wherein both the first extending surface section and the second extending surface section are inclined flat surface sections.

5. The lens module as described in claim 1, wherein each of the at least two flat surface sections has a ring shape.

6. The lens module as described in claim 1, wherein the at least two flat surface sections are located in a same plane.

7. The lens module as described in claim 4, wherein an angle included between the first extending surface section and the second extending surface section is an acute angle.

8. The lens module as described in claim 1, wherein the first lens is a round glass lens or a round plastic lens.

9. The lens module as described in claim 1, wherein the at least two flat surface sections are evenly spaced apart from one another.
